(19) United States
(12) Patent Application Publication
(10) Pub. No.: US 2005/0004820 A1
(43) Pub. Date: Jan. 6, 2005

(54) Means and methods for improving customer travel pleasure

(76) Inventor: David Lawrence LeMieux, Tehachapi, CA (US)

Correspondence Address: David L. LeMieux, 39 Hubbard Lane, Boulder, MT, 59632, US

(21) Appl. No.: 10/884,476

(22) Filed: Jul. 1, 2004

Related U.S. Application Data
(60) Provisional application No. 60/485,175, filed on Jul. 2, 2003.

(51) Int. Cl. G06F 17/60

(52) U.S. Cl. 705/5

(57) ABSTRACT

Means and methods of a ticket booking process are disclosed. In one embodiment airline carriers may improve customer-traveling pleasure by improving the probability of meeting specific customer travel desires. An interactive computer ticket booking system is used to allow customers to enter specific criteria that they feel would improve their traveling experience. This ticket booking service allows the carriers to provide their customers with more services and achieve higher customer satisfaction while also generating additional revenue.

### BACKGROUND OF THE INVENTION

This invention relates generally to the travel industry, and more particularly to providing a service, to a traveler or customer, to increase travel pleasure by increasing the probability of providing a seat assignment or providing another customer service request described within this invention.

Recently, carriers in the travel industry have been challenged to find new ways to attract travelers and to provide more services to their customers, to improve customer satisfaction. Carriers have also been challenged to find additional revenue sources. This invention shows embodiments that may attract more traveling customers and improve service to existing customers, by making travel a more pleasurable experience. Additionally, the embodiments provide more revenue to the carrier for providing improved travel services. Although embodiments of this invention may be applied to airline, boat, train, and bus carriers, it is described for illustration purposes using an airline carrier.

There are known in the art, Internet based interactive computerized on-line ticket booking services, at various web sites, that allow customers to purchase airline travel tickets. Typically, such services require the consumer to input their desired travel itinerary information such as the origination and destination cities and dates and approximate times for travel. Such ticket booking services typically search a database of an airline reservation system(s) of many carriers to find closely matching flight schedules.

Next the ticket booking service displays a list of flights and carriers for which seats are listed as being available, together with the fares for such flights, and the customer chooses a carrier offering a flight schedule and ticket price that most closely matches their itinerary and purchases the ticket.

The customer typically purchases the ticket, either by transmitting to the web site service, credit card information over the Internet, by calling a telephone number or possibly by transmitting payment information by facsimile. Many Internet travel web site services also provide an e-mail service through which itinerary information is transmitted to the customer.

There are also known in the art, Internet based interactive computerized on-line matchmaking or dating services that allow customers to meet each other. Such services commonly provide customer-controlled perusal of database search results while also providing customers with the ability to perform searches based on customer-specified criteria, e.g. location criteria. These services also often provide customers with at least some search results, based on what the customer desires, regardless of what search criteria they specify.

In order to produce a search result, regardless of the search criteria specified, these services commonly perform a series of searches through a search database, applying successively less restrictive search criteria until at least one positive result (match) is obtained. In this manner, a desired number of matching entries is almost always guaranteed, with the more desirable entries being reported first.

Commonly matchmaking service providers maintain a database of subscriber information that is searched to find at least one subscriber matching a customer's search criteria. The subscriber information includes preferences of subscribers to the service. Customers access the database by a computer to enter personal preference data and search criteria. Personal preference and the subscriber information includes at least: a gender preference; a geographic location preference; an age preference; appearance preferences; religious belief preferences; educational level preferences; and a goal preference, and wherein the goal preference is one of “romance”; “friendship” or “a walk on the wild side”, wherein the geographic location preference is at least one of a postal code, a country, a city, a suburb, a block, or a street.

The database may also contain customer information such as a personal profile by each customer subscriber and a profile or description of the person that they would like to meet. A percentage match parameter value is set to an initial value of say 70%; and then the database is repeatedly searched for records matching the personal preferences of the user by at least the percentage match parameter value. The percentage match parameter is reduced by a value of say 10%, until at least a required number of matching records are found. The required number of matching parameters is never less than one. The matching records are sometimes reported to the customer along with the percentage match for each reported record and a degree of match of each of the search criteria.

However, there remains a need for carriers to generate additional revenue by combining art from interactive computerized Internet ticket booking and purchasing services with Internet dating or matchmaking services. Although art from other technologies may also be used, is should be appreciated that there are numerous embodiments that could result from this combination and that all embodiments would essentially achieve generating additional revenue for a carrier by providing the additional customer service of improving travel satisfaction.

The current ticket booking process only provides a nearly random seating assignment to the customer and does not permit the customer to indicate specific travel needs or request travel desires. Thus there is a current business need of carriers to improve customer service and satisfaction by providing new ticket booking services. By meeting this business need, travelers will have a more pleasurable traveling experience and this will improve the carrier's market.

### BRIEF DESCRIPTION OF THE INVENTION

This invention relates to the travel industry and more specifically to providing a service to a traveler or customer to increase travel pleasure by increasing the probability of providing a customer specific seat assignment or providing any other customer service request described within this invention.

This invention relates to a computer-implemented service, and more particularly, to a method, system, and apparatus for computer searching and matching of database entries based on customer selectable search criteria; such that travelers with correlating interests, backgrounds, and/or desires are more likely to be seated near each other. In particular, this invention provides an on-line computer interactive service enabling the customer to participate in improving travel satisfaction, by increasing the likelihood that they will enjoy their traveling companion, while also increasing ticket sales profits for the carrier.

This new service will allow customers to provide specific travel request criteria that may improve their traveling pleasure. For example, a customer may provide criteria indicating a desired travel companion, among all the travelers seeking passage from the carrier. The computer system may then assign the customer and a non-randomly selected traveling companion to occupy adjacent or nearby seats during travel. As another example, travelers may be allowed to mutually select each other's company through inter-active correspondence through the Internet, before travel departure.

In another example, travelers may provide criteria that a computer program or system will use to increase the probability that the traveling customer's criteria or travel desires are achieved and therefore the service provides the customer with increased traveling pleasure. A customer's criteria is not limited to criteria designed to identify a matching traveling companion. For example, customer criteria may relate to traveling environment, such as requesting a vacant adjacent seat. With this invention, a computer travel service or carrier providing this service, may use technologies know in the art to improve customer service and satisfaction.

### BRIEF DESCRIPTION OF THE DRAWINGS

The invention will become more clearly understood from the following detailed description in connection with the accompanying drawings, in which:

FIG. 1A is a ticket booking flow diagram according to one embodiment of the invention;

FIG. 1B is a flow diagram of one embodiment of the invention;

FIG. 1C is a flow diagram of an alternate embodiment of the invention;

FIG. 2 is shows a typical database record of the customer profile and various Customer Service Requests (CSR) criteria; and

FIG. 3 is a matrix that permits the customer to weight their CSR criteria according to their desires.

### DETAILED DESCRIPTION OF THE INVENTION

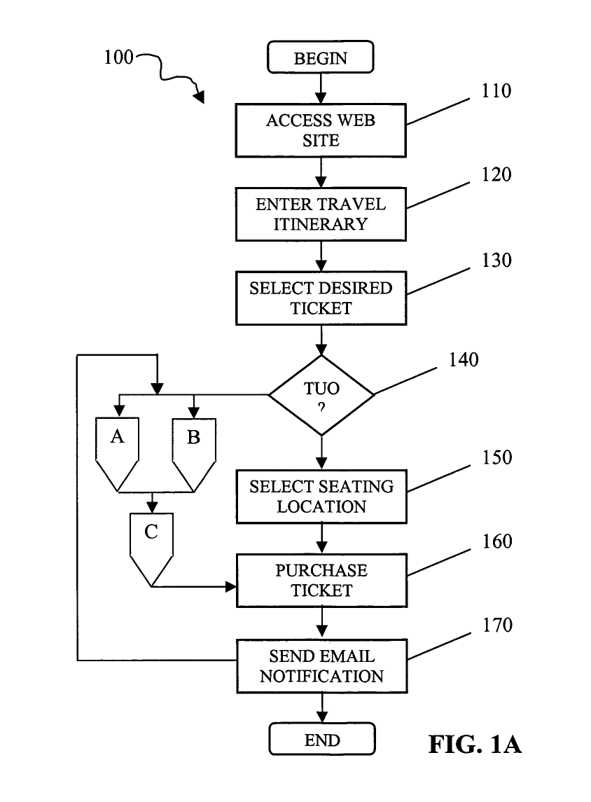

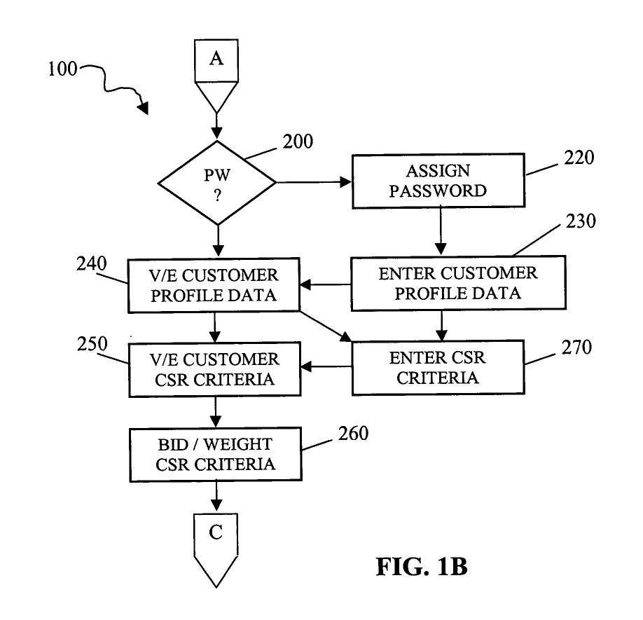

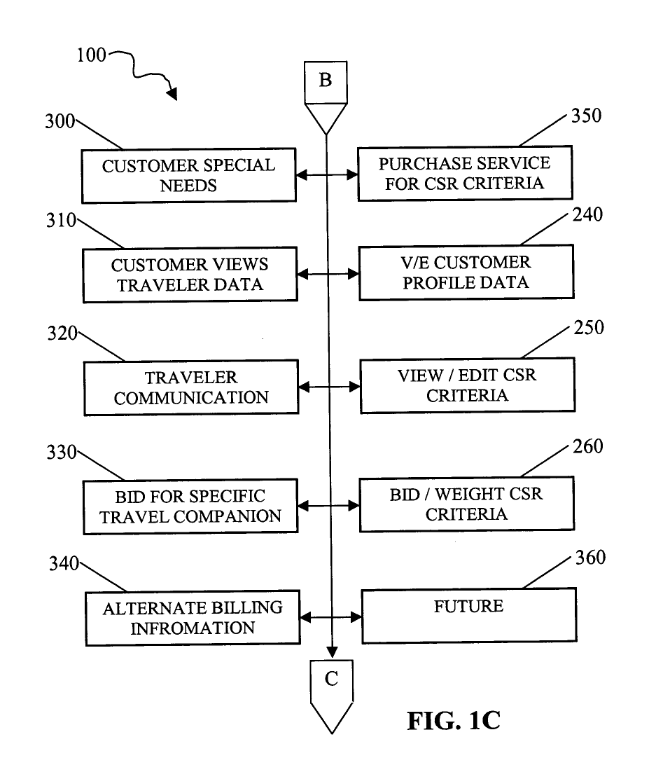

FIG. 1 is a ticket booking flow diagram showing an embodiment of the ticket purchase process 100 when a ticket is purchased on the Internet or World Wide Web (WWW). When booking a ticket, a customer accesses a reservation web site 110 to book a ticket and enters their desired travel itinerary 120. The desired travel itinerary 120 includes desired city pairs and desired traveling dates and times. The reservation web site then searches a database (not shown) and displays a list of carriers, showing travel itineraries and ticket prices (also not shown in FIG. 1). Next the customer reviews the displayed travel itineraries and selects a desired ticket 130 for purchase.

Next, the customer determines if they would like to upgrade their service at the Ticket Upgrade Option (TUO) step 140 after selecting a desired ticket in step 130. The TUO 140 allows the customer to choose to upgrade their ticket to improve their traveling comfort or pleasure, for an additional nominal fee or cost, and takes the customer to FIG. 1B or in an alternate embodiment to FIG. 1C. FIG. 1B and FIG. 1C will be described in more detail later in this patent.

If the customer does not select the TUO option in step 140, the customer may select a seating location 150 and then purchase their ticket 160. Some configurations do not allow the customer to select a seating location 150, so the customer may bypass step 150 and go directly to ticket purchase step 160.

After the customer purchases their ticket at step 160, by submitting payment information such as from a credit card, the ticket web site sends an email notification 170 to the customer. The email notification 170 includes travel itinerary and ticket cost and also includes information about the upgraded ticket, if an upgraded ticket was selected in step 140.

It is appreciated that many tickets are purchased by representatives of the traveling customer, for example a secretary or a travel agent may purchase the ticket on behalf of the customer. Due to increased ticket cost or not knowing the customer's upgrade preference criteria, these representatives may not choose the TUO at step 140. Therefore the email notification 170 also serves to provide the customer with an opportunity to upgrade their ticket, bypassed earlier at step 140, even after the ticket has been purchased 160. In application, this would be achieved by the customer selecting a web link, provided in the email notification 170, that would take the customer directly to purchase an upgraded ticket (FIG. 1B). Further, the customer may have the option (not shown in FIG. 1A) to provide payment using a different credit card information than was used to purchase the ticket 160.

Thus if an upgraded ticket was not purchased by the customer or the customer's representative, the email notification 170 provides a web link to allow the customer to upgrade their ticket 140, even after the ticket was purchased 160. However if a ticket upgrade was purchased by the customer or the customer's representative, the email notification 170 provides a web link to allow the customer to view and modify their ticket upgrade criteria or weight score levels (to be discussed later in this patent) or other data shown in FIG. 1B and FIG. 1C flow charts, anytime prior to departure.

In this invention, if the customer chooses the TUO 140, they begin the ticket upgrade process shown in the FIG. 1B or in an alternate embodiment, shown in FIG. 1C.

In one embodiment and referring to flow chart 100 of FIG. 1B, the customer enters a password 200 if they have been assigned a password from a previous ticket purchase. If the password 200 is accepted the system automatically populates data entry fields, described later in this patent, according to the last customer entry by retrieving customer data from a database (not shown). This allows the customer to view and edit historic customer profile data 240 to match their travel desires for the ticket being purchased. Next, the customer proceeds to view and edit Customer Service Request (CSR) criteria in step 250 and bid and weight CSR criteria in step 260.

However, if the customer is new and does not have a password, a password is assigned in step 220. Next the customer enters profile specific data in step 230 and then proceeds to step 240 where they complete a review and make final edits to their customer profile data 230. Next, the customer is directed from step 240 to enter CSR data 270 according to their personal travel pleasure criteria. Finally the customer conducts a final inspection of their CSR criteria selections at step 250 and enters a bid and/or weights CSR criteria in step 260.

Details of data contained in steps 230, 240, 250, 260, and 270 are presented later in this patent, but it should be appreciated that steps in flow chart 100 may be reordered without changing this invention. Therefore the embodiment described is for purposes of illustration and are not limiting.

In an alternate embodiment and referring to flow chart 100 of FIG. 1C, the customer may select any of the step options shown. By illustration, in step 300 the customer may provide the carrier with advance notice of any special travel needs. For example a wheel chair between flights. In step 310 the customer may view pictures or detailed travel information of other travelers. In step 320 the customer may access the travel service database and exchange email communication with other travelers prior to travel departure. For example, they customers may ask each other specific questions such as their favorite color.

In step 330, the customer may bid or otherwise request to be seated with a specific traveling companion. For example, perhaps a customer found interest in a co-traveler in step 320 and wanted to meet them personally. In step 340, the customer may provide separate billing information for the TUO service. For example the customer may wish to bill fees related to the TUO service to one credit card while billing fees related to general ticket purchase 160 with a separate credit card. In step 350, the customer may purchase service for specific CSR criteria. For example, the customer may directly purchase an assigned adjacent vacant seat, if such as seat for the flight is not sold out. The customer will also be provided identical options to those indicated in FIG. 1B and these are illustrated using like step numbers 240, 250, and 260, and like block descriptions. Step 360 is a block indicating that the computer system may provide other future services. It should be appreciated that the customer may add detailed personal profile information including a short description of themselves and what they are looking for in a traveling companion and also including a photograph of themselves.

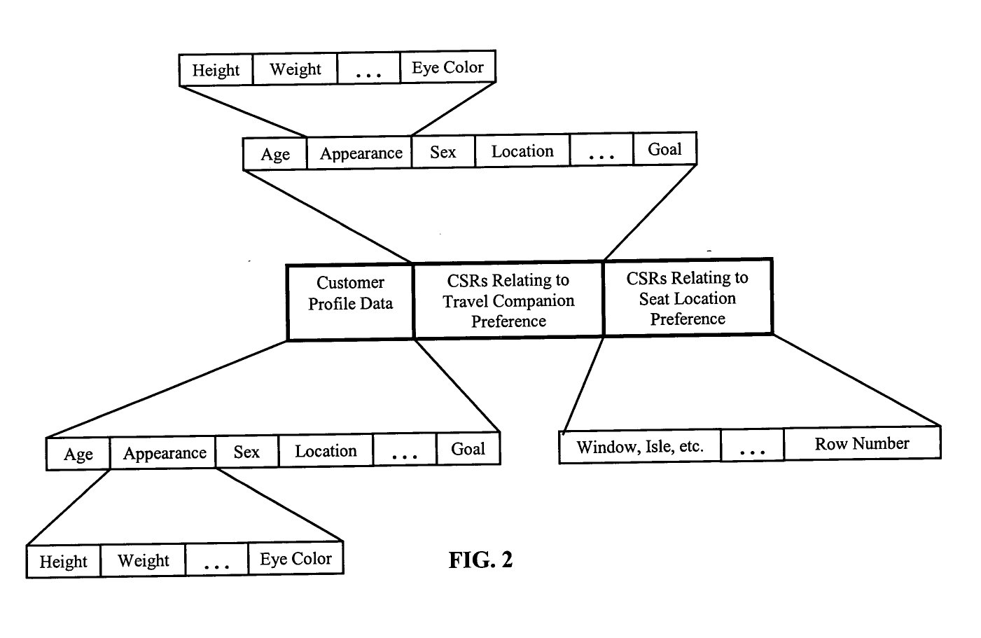

FIG. 2 is a diagram that depicts details of database record containing customer profile data 230 and 240 and customer CSR selection criteria 270 and 250. This diagram illustrates examples of customer profile data and customer CSR data relating to a to travel companion preference, seat location preference, and other preference criteria shown.

It is appreciated that customer profile data 230 and 240, may include the customer age, appearance, sex, general location where the customer lives, and travel goals, as examples of information computer algorithms may use to determine their seat assignment. By illustration, more details may be included about the appearance of the customer, for example height, weight, and eye color. Likewise more details may be included about the customer's travel goals, for example the customer may or may not enjoy conversation with a traveling companion during travel. Customer profile information is not limiting and is presented here as an example.

It is also appreciated that customer CSR criteria 270 and 250, may include details of what the customer would most appreciate in a traveling companion. This information would increase the probability of the service achieving customer desires such as being seated adjacent or nearby a travel companion matching the customer's profile data. Details of customer CSR criteria 270 and 250, may therefore include similar data to the customer profile data 230 and 240.

This diagram briefly illustrates examples of information the customer may use to improve their traveling pleasure when purchasing an upgraded ticket. These examples provided are intended to be an illustration and not limiting.

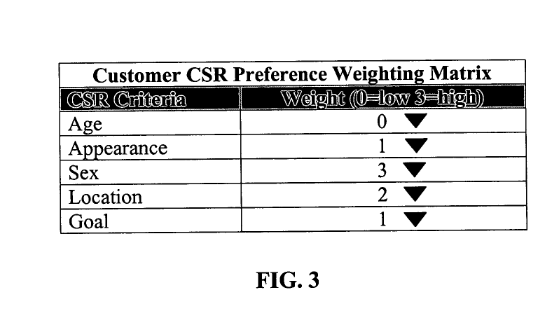

FIG. 3 shows and example matrix illustrating step 260 in FIG. 1B. A table of customer CSR criteria is listed and for each criteria the customer is permitted to enter and integer score value or weight to prioritize the importance of the CSR criteria to the customer. In one example, the weight values are considered to increase ticket cost with increasing integer value. Generally the sum of the integer weight values will determine the ticket upgrade price. For example, if a first customer enters high weighted values on three criteria their ticket upgrade cost will be more than a second customer that enters low weighted values on the same three criteria. However, the first customer will be given seating preference over the second customer.

Although not shown in FIG. 4, it is appreciated that the customer will pay a nominal fee, in addition to the ticket price, for the ticket upgrade service of increasing the probability of experiencing a more pleasurable traveling experience. It is appreciated that numerous pricing strategies can be devised. In one example, customers interactively bid against each other for high demand CSR criteria. Also, a customer may be provided with a real-time ticket upgrade cost (not shown) to inform the customer of the relationship between CSR weight assignments and the ticket upgrade cost. In a contrasting example, carriers may provide free ticket upgrade services as long as the customer purchases their ticket a specified number of days before traveling.

It should be appreciated that the fee for the ticket upgrade option may only be a maximum price and that the actual price may be based upon the increased probability level or service satisfaction level provided to the customer. For example, some flights may have traveling companions that are all male and the customer's highest weighted criteria is a female traveling companion. In this case the customer would not be billed for this upgraded ticket feature, because it was not possible to improve the probability of increasing their travel pleasure according to their upgraded ticket weighting criteria.

The weight that the customer assigns each CSR criteria influences how the computer program or system matches the customer with a seating companion or otherwise determines their seating assignment from other CSR criteria. In application, the entry table allows the customer to prioritize their requirements based on their traveling desires for pleasure or comfort. This also allows the customer to increase the probability of a match for criteria that they assign a high weight score.

By example in the FIG. 3, the customer CSR criteria are listed in the column on the left and the customer places a integer score from zero to three to indicate how important each CSR criteria is to the customer. In this example, the customer indicates that “sex” is the most important criteria, with a weight of three, while “age” is the least important criteria, with a weight of zero. Further “appearance” and “goal” criteria are the weighted more than “age” criteria, but less than “location” criteria. Therefore, the system would match the customer with their choice of “sex” above all other criteria, followed by “location,” then equally by “appearance” and “goal” and finally by “age.”

It is also appreciated that the computer system may also provide interactive probability estimates of a customer achieving their key or highly weighted CSR criteria. These estimates may be based on the flight and the estimates may change as the flight becomes more fully booked. Otherwise these estimates may be based on historical flight information.

To entice customers to book their tickets well in advance of the travel date, some carriers may allow CSR criteria to be provided on a first-come first-serve basis. For example, if a customer placed a minimum bid via a weight value for an empty adjacent seat well in advance, the customer may be guaranteed this CSR without cost.

In application for upgraded tickets, the computer system will automatically use all search a database to achieve customer's travel desires using all search methods known in the art. One goal of the search engine is to make traveling companion matches by providing a seat assignment for the customer that will increase the probability of a more enjoyable journey. Another goal of the computer system is to increase the probability of customer travel pleasure. Yet another goal of the computer system is to provide the customer with their CSR criteria requests.

Also in application, the customer purchases a ticket including an upgraded ticket as described above. Prior to travel, the customer receives seat assignment location upon picking up their printed ticket, this is typically in the form of a electronic ticket issued just prior to departure. In addition to the flight and seating assignment information, the ticket may also indicate the billed fee for an upgraded ticket and also provide a probability index indicating the level of matching the customer's CSR criteria.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

The embodiments illustrated and discussed herein are intended only to teach those skilled in the art the best way known by the inventor to make and use the invention. Nothing in the specification should be considered as limiting in scope of the present inventions. Changes could be made by those skilled in the art to produce equivalent devices without departing from the invention. It should be clearly understood also that there are numerous ways to achieve the intent of this invention and this disclosure should not be limiting to any of these ways. Additionally, this invention leans on language in referenced United States patents and should be considered to include such language for more description, but this was omitted in the interests of keeping this submittal succinct.

1. A method to allow carriers to generate increased revenue by offering customers a ticket upgrade option in the ticket booking procedure, said method comprising:
a ticket upgrade option that allows the customer to enter personal profile data;
a ticket upgrade option that allows the customer to enter customer service requirement criteria;
a ticket upgrade option that allows the customer to interactively bid on ticket upgrade features for improving travel pleasure;
a ticket upgrade option that allows the customer to interactively weight ticket upgrade features for improving the probability that the customer will receive said features; and
a ticket upgrade option that allows the customer to indicate special travel needs.

2. A means in accordance with claim 1 wherein a reservation web site may store customer data in a database and search the database to match the customer with other travelers that the customer may find compatable.

3. A means in accordance with claim 1 wherein a reservation web site allows the customer to interactively view and edit at least one of the following: customer data and customer service request criteria and customer service request weight values and upgrade ticket costs.

4. A method for a computer service to search a database for the purpose of increasing the probability of achieving customer travel satisfaction.

5. A method in accordance with claim 4 wherein travel satisfaction is based the data provided by the customer.

6. A method in accordance with claim 1 wherein a customer is billed for ticket upgrade services based on the weight the customer assigns to a customer service request for the travel.

7. A method in accordance with claim 1 wherein a customer may interactively view and edit their data anytime prior to travel.

8. A method in accordance with claim 1 wherein a customer may view data of other travelers to determine if the customer would like to specifically select a traveling companion.

9. A method in accordance with claim 8 wherein a customer may exchange information with other travelers prior to travel.

10. A method in accordance with claim 1 wherein a computer system automatically provides a customer with a seat assignment, to increase the probability of travel pleasure, by using one of the following: customer weight score data for specific CSR criteria provided by the customer and bid information for specific CSR criteria provided by the customer.

11. A means for an interactive travel service, that combines common ticket booking and purchasing methods with common dating services, known in the art, to increase customer traveling satisfaction.

12. A method in accordance with claim 1 wherein customers may be paired by seating assignment locations, as traveling companions, for the pleasure of one or more of the travelers.

13. A means wherein the customer may query the travel service, to search and view profile data of other travelers, based on specific search criteria.

14. A means for the travel service to bill the customer for the purchase of a ticket upgrade.

15. A method in accordance with claim 14 wherein the bill amount may be automatically adjusted downwards if the travel system could not significantly increase the probability of improving customer travel satisfaction because the customer's weighted criteria were not met.

16. A travel system that permits a customer to indicate what would bring them travel pleasure.

17. A method in accordance with claim 16 where said travel pleasure is improved when the travel service improves the travel experience, by matching the customer with at least one of any travel companion preference data and any CSR criteria.

18. A ticket booking system in accordance with claim 1 wherein the customer books a ticket on the Internet.

19. A ticket booking system that provides a ticket upgrade report to the customer when the printed ticket is issued prior to travel.

20. A report in accordance with claim 19 where said report includes one of the following: the ticket upgrade cost and the increased probability score determined by the travel system and the seat assignment of the customer's designated traveling companion.
